(19) United States
(12) Patent Application Publication
(10) Pub. No.: US 2012/0283462 A1
(43) Pub. Date: Nov. 8, 2012

(54) NANOPARTICLES HAVING REDUCED LIGAND SPHERES

(75) Inventors: Frank Stefan Riehle, Umkirch (DE); Yunfei Zhou, Freiburg (DE); Michael Krüger, Emmendingen (DE); Gerald Urban, Freiburg (DE)

(73) Assignee: BAYER INTELLECTUAL PROPERTY GMBH, Monheim (DE)

(21) Appl. No.: 13/517,025

(22) PCT Filed: Dec. 17, 2010
(86) PCT No.: PCT/EP2010/070039

§ 371 Date: Jul. 25, 2012

(30) Foreign Application Priority Data
Dec. 21, 2009 (DE) 10 2009 060 034.5

(51) Int. Cl. C07F 3/08

(52) U.S. Cl. 556/118

(57) ABSTRACT

The invention relates to the technical field of nanoparticles. The subject matter of the invention is a method for treating nanoparticles for the reduction of ligand spheres.

The present invention relates to the technical field of nanoparticles. The present invention provides a process for treatment of nanoparticles to reduce the size of the ligand sphere.

Nanoparticles (also called nanomaterials) are playing an ever more important role in everyday products. Nanoparticles have a huge surface area in relation to their volume. In comparative terms, more atoms therein are present at the surface than in the case of larger bodies. As a result, they have novel or altered properties which offer new possible uses.

Semiconductive nanoparticles are, for example, the subject of current research and development work in the field of organic/inorganic hybrid solar cells (see, for example, C. W. Tang, Appl. Phys. Lett. 48, 183 (1986); N. S. Sariciftci, L. Smilowitz, A. J. Heeger, and F. Wudl, Science 258, 1474 (1992); W. U. Huynh, J. J. Dittmer, and A. R Alivisatos, Science 295, 2425 (2002)). Compared to the purely inorganic silicon solar cells, organic/inorganic hybrid solar cells have the potential of less expensive production and large-area production on flexible substrates.

Organic/inorganic hybrid solar cells based on conductive organic polymers as electron donors, for example poly(3-hexylthiophene) (P3HT), and inorganic semiconductor nanoparticles, for example CdSe nanoparticles, are known from the prior art (see, for example, N. C. Greenham, X. Peng, and A. P. Alivisatos, Physical Review B 54, 17628 (1996); X. Peng, L. Manna, W. Yang, J. Wickham, E. Scher, A. Kadavanich, A. P. Alivisatos, Nature 404, 59 (2000)).

Extensive research work has been published regarding the synthesis of various morphologies of CdSe nanoparticles and use thereof in what are called bulk heterojunction solar cells. Hybrid solar cells based on what are called nanorods (B. Sun, and N. C. Greenham, Phys. Chem. Chem. Phys. 8, 3557 (2006)), tetrapods (B. Sun, H. J. Snaith, A. S. Dhoot, S. Westenhoff, and N. C. Greenham, J. Appl. Phys. 97, 014914 (2005)) and hyperbranched CdSe nanoparticles (I. Gur, N. A. Fromer, C. Chen, A. G. Kanaras, and A. P. Alivisatos, Nano Lett. 7, 409 (2007)) have exhibited the highest efficiencies to date of 2.6%, 2.8% and 2.2%.

The elongated or branched nanoparticles possess directed conductor tracks for electrons, such that electrons en route to the electrode have to overcome fewer interparticulate barriers than in the case of spherical particles of the same volume.

The performance of a solar cell depends not only on the form of the nanoparticles but also on the solubility and surface characteristics of the nanoparticles, which can considerably influence the electron transfer between the particles. Often, in the course of production of nanoparticles, ligands with long alkyl radicals are used, which are intended to prevent aggregation of nanoparticles. In the solar cell, these ligands with alkyl radicals, however, are disadvantageous since they can lead to electrical passivation of the nanoparticles.

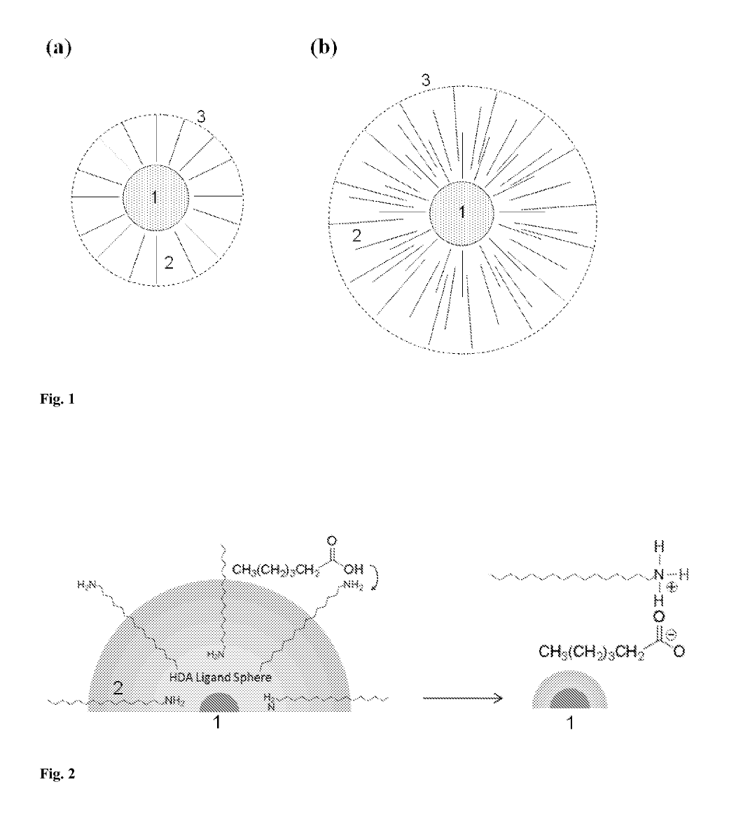

In the simplest case, nanoparticles are stabilized by a surface-active ligand and protected from aggregation and oxidation. This surface-active ligand usually comprises amphiphilic compounds with a polar head group which binds to the surface of the nanoparticle, and a long nonpolar lipophilic or hydrophobic tail which is directed outward (see FIG. 1a). In reality, in very rare cases, a monomolecular ligand layer (FIG. 1a) will be bound around the semiconductive core; instead, a multilayer ligand sphere is arranged around the semiconductive core, which consists of several amphiphilic molecules bound with different strengths, which leads to an effective enlargement of the particle size (see FIG. 1b).

In order to increase the charge transfer both between the nanoparticles and the conductive polymer surrounding them and between individual nanoparticles in hybrid solar cells, it is customary to exchange the ligands around the nanoparticles after the synthesis thereof (see, for example, W. U. Huynh, J. J. Dittmer, W. C. Libby, G. L. Whiting, and A. P. Alivisatos, Adv. Funct. Mater. 13, 73 (2003); S. Ginger and N. C. Greenham, J. Appl. Phys. 87, 1361 (2000); L. Han, D. Qin, X. Jiang, Y. Liu, L. Wang, J. Chen, and Y. Cao, Nanotechnology 17, 4736 (2006); D. Aldakov, F. Chandezon, R. D. Bettignies, M. Firon, O. Reiss, A. Pron, Eur. Phys. J. Appl. Phys. 36, 261 (2007); D. J. Milliron, A. P. Alivisatos, C. Pitois, C. Edder, and J. M. J. Frechet, Adv. Mater. 15, 58 (2003)).

The treatment of nanoparticles with pyridine is an effective method frequently described in the literature for increasing the efficiency of a solar cell. For example, Olson et al. (Solar Energy Materials & Solar Cells 93, 519 (2009)) report a solar cell based on CdSe/P3HT, which had a maximum efficiency of 1.77% once the ligands had been exchanged for comparatively short-chain butylamine after the synthesis of the CdSe nanoparticles.

The hybrid solar cells which are described in the literature and are based on inorganic nanoparticles and organic conductive polymers have a low efficiency compared to the conventional silicon solar cells. The production costs of hybrid systems are lower than those for conventional silicon solar cells, but the difference is not so great that it could compensate for the lower efficiency. There is still a great need for an increase in the efficiency of hybrid solar cells.

Proceeding from the known prior art, the technical problem addressed is thus that of enhancing the efficiency of hybrid solar cells. The aim is to reduce especially the electrical barrier layer between the semiconductive nanoparticles and/or between the nanoparticles and the polymer surrounding them in a hybrid solar cell.

It has been found that, surprisingly, the size of the ligand sphere adhering to nanoparticles can be reduced by treating the nanoparticles with a substance which enters into a compound with the ligands, the compound being separable from the nanoparticles in a simple manner by washing.

As a result of the reduction in size of the ligand sphere, the electrical barrier layer around the nanoparticles falls. In addition, the effective particle size of the nanoparticles also falls and the nanoparticles can more closely approach one another. This lowers the interparticulate electrical barrier between the nanoparticles, and the reduction in the ligand sphere leads to increased efficiency in hybrid solar cells in which the nanoparticles thus treated are used.

The present invention therefore provides a process for treatment of nanoparticles to which ligands R_{L}—X are bonded by a polar head group X and a tail R_{L}, which is characterized in that the nanoparticles are contacted with a substance Y which forms, with the ligands R_{L}—X, a chemical compound which can then be removed from the nanoparticles by washing.

A nanoparticle is understood to mean a body whose greatest dimension is less than 1 μm. Preference is given to using nanoparticles whose greatest dimension is in the range from 1 nm to 100 nm, more preferably in the range from 1.5 nm to 50 nm and most preferably in the range from 2 nm to 40 nm (measured by means of a transmission electron microscope).

The nanoparticles are preferably materials which have a conductive or semiconductive inorganic core around which ligands are arranged.

Preference is given to using nanoparticles having a core of one or more of the following materials:
II-VI semiconductors, for example composed of CdS, CdSe, CdTe or ternary mixed systems of these materials, for example CdTe₍₁₋ₓ₎Seₓ (0<x<1), composed of ZnO, ZnS, ZnSe, ZnTe or ternary mixed systems of these materials, composed of HgS, HgSe, HgTe or ternary mixed systems of these materials,
III-V semiconductors, for example InP, InAs, GaP or ternary mixed systems of these materials,
IV-VI semiconductors, for example PbS, PbSe, PbTe or ternary mixed systems of these materials,
Bi₂S₃, Bi₂Se₃, Bi₂Te₃, Sb₂S₃, Sb₂Se₃, Sb₂Te₃ or ternary mixed systems of these materials.

Particular preference is given to using CdS, CdSe, CdTe or ternary mixed systems of these materials, for example CdTe₍₁₋ₓ₎Seₓ (0<x<1), very particular preference being given to using CdSe.

The nanoparticles may be entirely or partly amorphous, polycrystalline or monocrystalline. The nanoparticles are preferably crystalline, more preferably monocrystalline.

The synthesis of nanoparticles, especially of nanoparticles with a conductive and/or semiconductive core, typically takes place in a solution in which one or more coordinating or complexing substances are present, which bind to the nanoparticles. These coordinating or complexing substances are intended to prevent stabilization of the nanoparticles and agglomeration of the small particles.

The reaction solvent in which the nanoparticles are synthesized may itself be a coordinating substance; it is likewise conceivable that one or more coordinating substances are added to a solvent. The coordinating substance adheres as a ligand sphere around the synthesized nanoparticles (see FIGS. 1a and 1b).

Coordinating substances customarily used are amines, alkylphosphines, alkylphosphine oxides, fatty acids, ethers, furans, phosphatic acids, pyridines, alkenes, alkynes and combinations thereof. The substances mentioned can be used in pure form or in the form of mixtures.

Suitable amines include, but are not restricted to, alkylamines such as dodecylamine and hexyldecylamine, etc.

Examples of alkylphosphines include, but are not restricted to, the trialkylphosphines, tri-n-butylphosphine (TBP), tri-n-octylphosphine (TOP), etc.

Suitable alkylphosphine oxides include, but are not restricted to, trialkylphosphine oxide, tri-n-octylphosphine oxide (TOPO), etc.

Examples of fatty acids include, but are not restricted to, stearic and lauric acids.

Examples of ethers and furans include, but are not restricted to, tetrahydrofuran and the methylated forms thereof, glyme, etc.

Suitable phosphatic acids include, but are not restricted to, hexylphosphonic acid, tetradecylphosphonic acid and octylphosphinic acid, and preferably a combination with an alkylphosphine oxide, for instance TOPO.

Examples of pyridines include, but are not restricted to, pyridine, alkylated pyridines, nicotinic acid, etc.

The term “alkyl” as used herein relates both to a branched or unbranched, saturated hydrocarbyl group having typically 1 to 24 carbon atoms, for instance methyl, ethyl, n-propyl, isopropyl, n-butyl, isobutyl, t-butyl, octyl, decyl, tetradecyl, hexadecyl, eicosyl and tetracosyl, and to cycloalkyl groups, for instance cyclopentyl and cyclohexyl. Similarly, alkanes are saturated hydrocarbon compounds, for instance methane, ethane, etc.

“Alkenyl” and “alkynyl” groups derive from the alkyl groups in the known manner, in that they have at least one carbon-carbon double and triple bond respectively.

The compounds bound to the nanoparticle as the ligand R_{L}—X may be the coordinating compounds listed above, but they may also be compounds which form from the coordinating compounds listed above by uptake of one or more protons or by release of one or more protons.

The ligands R_{L}—X have a polar head group X. The tail is preferably nonpolar.

A polar head group is understood to mean a molecular constituent which bears one or more electrical charges, i.e. is singularly or multiply positively or negatively charged, or which has a permanent electrical dipole moment.

A nonpolar tail is understood to mean a molecular constituent which is not electrically charged and does not have a permanent electrical dipole moment.

The ligand R_{L}—X is bonded to the nanoparticle via the head group X.

X is preferably a carboxylate group COO⁻ or an amino group NR₁R₂R₃ with the R₁ to R₃ radicals, where the R₁ to R₃ radicals may, for example, each be hydrogen, alkyl, alkenyl, alkynyl or aryl groups. The tail is preferably an alkyl, alkenyl, alkynyl or aryl group, more preferably an aliphatic alkyl group. The R₁, R₂ and R₃ radicals may be the same or different.

The nanoparticles surrounding by the ligands R_{L}—X are, in accordance with the invention, contacted with a substance Y which forms a chemical compound with the ligands R_{L}—X. The compound can be removed from the nanoparticles by washing.

The compound is preferably a salt, i.e. there is preferably an acid-base reaction between the ligands R_{L}—X and the substance Y to form an ionic compound.

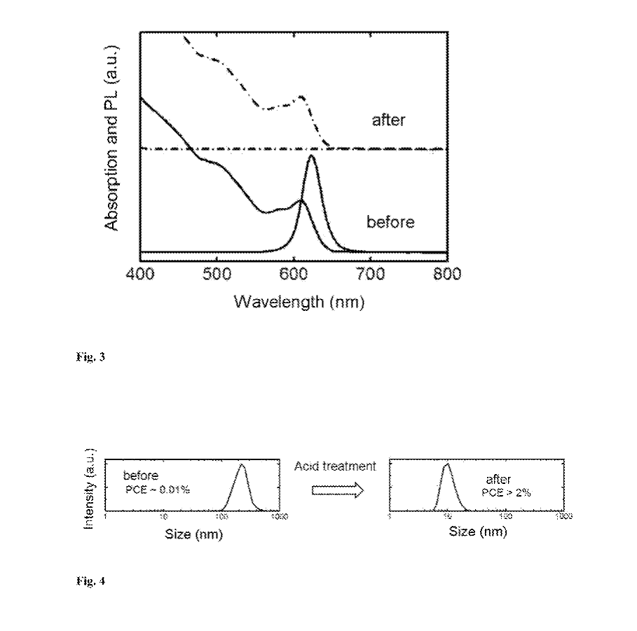

The substance Y leads to weakening of the bond between the ligands R_{L}—X and the nanoparticle (see FIG. 2).

When the head group X of the ligand R_{L}—X is a carboxylate group COO⁻, the substance Y used is preferably an amine NR₁R₂R₃ or an ammonium compound ⁺NR₁R₂R₃R₄ with the R₁ to R₄ radicals, where the R₁ to R₃ or R₁ to R₄ radicals may, for example, each be hydrogen, alkyl, alkenyl, alkynyl or aryl groups.

When the ligand R_{L}—X is a compound having an amino group NR₁R₂R₃ with the R₁ to R₃ radicals, where the R₁ to R₃ radicals may, for example, each be hydrogen, alkyl, alkenyl, alkynyl or aryl groups, the substance Y used is preferably a carboxylic acid or a carboxylate compound.

The nanoparticles are contacted with the substance Y at a temperature at which the ligands R_{L}—X and the substance Y react with one another, but at which there are no side reactions of the nanoparticles or of the solvent. More particularly, the temperature should be within a range at which no particle growth takes place, for example, as a result of what is called Ostwald ripening. Suitable substances Y and conditions can be determined empirically in a simple manner by routine tests.

The inventive treatment can be effected when the nanoparticles are in the solid state. The inventive treatment is preferably effected in a dispersion in which the nanoparticles, if possible, are present in individualized dispersion, such that they have good accessibility from all sides.

Known measures which promote the mixing of the substances, for example stirring, can accelerate the process according to the invention.

In one embodiment of the process according to the invention, the substances R_{L}—X and Y are matched to one another such that the resulting chemical compound is soluble in the solvent or solvent mixture used for purification, such that it can be removed in a simple manner by washing. Corresponding conditions and substances can be determined empirically in a simple manner by routine tests.

The treatment is typically followed by a washing step. For this purpose, preference is given to supplying a reagent which leads to precipitation of the nanoparticles to the mixture comprising nanoparticle dispersion and substance Y. By means of centrifugation, for example, the nanoparticles can be separated from the substance Y which is preferably soluble in the purifying solution.

It is likewise conceivable that the substances R_{L}—X and Y, the dispersant/solvent and/or the process conditions (e.g. pressure, temperature) are selected such that the reaction between R_{L}—X and Y leads to a chemical compound which is insoluble or only of low solubility in the nanoparticle dispersion. In such a case, the chemical compound between R_{L}—X and Y can be separated from the nanoparticle dispersion, for example by means of centrifugation.

The process parameters which lead to a sparingly soluble or insoluble compound between R_{L}—X and Y are either known to those skilled in the art or can be determined empirically in a simple manner by routine tests.

The resulting nanoparticles have, after the inventive treatment, a ligand sphere of reduced size extending as far as a monomolecular layer.

The present invention further provides nanoparticles which have been subjected to the process according to the invention.

The further integration of nanoparticles treated in accordance with the invention into a photovoltaic cell leads, due to the reduced isolating ligand layer, to improved charge transport from nanoparticle to nanoparticle and/or else between the conductive polymer by which the nanoparticles are surrounded in the photovoltaic cell and the nanoparticles, and hence to a reduction in competing recombination processes.

In addition, the inventive treatment generally also leads to increased solubility of the nanoparticles in the photoactive layer composed of nanoparticles and conductive polymer, which has further positive effects on the efficiency of the hybrid solar cell.

Thus, the use of nanoparticles treated in accordance with the invention in hybrid solar cells also forms a further part of the subject-matter of the present invention.

The invention is illustrated in detail hereinafter by examples, without restricting it thereto.

FIG. 1a shows a schematic of a nanoparticle (1) with a monomolecular layer of ligands (2). These ligands form the ligand sphere around the nanoparticle. The dotted circle (3) represents the effective particle size.

FIG. 1b shows a schematic of a nanoparticle (1) with several layers of more or less strongly bonded ligands (2). The effective particle size (shown by the dotted circle (3)) is larger than in the case of FIG. 1a.

The inventive treatment of nanoparticles allows the effective particle size of the nanoparticles to be reduced, by reducing the number of bound ligands. This is shown schematically in FIG. 2: a ligand sphere is present around a core (1). The ligands (2) are amine compounds. The inventive treatment of the nanoparticles with a carboxylic acid results in formation of a salt which can easily be removed from the nanoparticle. This reduces the size of the ligand sphere and lowers the effective particle size.

### EXAMPLE 1 (NONINVENTIVE)

### 1.1 Preparation of a Cd Precursor

1 mmol of red-brown cadmium oxide (CdO) and 3.5 mmol of colorless stearic acid (HSA) were heated to 200° C. under inert gas with a catalytic amount of succinic acid for 5-60 minutes. The reaction, which led to the formation of cadmium stearate (Cd(SA)₂), was ended once a clear, colorless solution was obtained. The Cd(SA)₂, which is solid at room temperature, was usable without further workup steps for synthesis of CdSe nanoparticles. A slight excess of HSA was required to fully convert CdO or to obtain a colorless solution.

### 1.2 Preparation of an Se Precursor

1 mmol of black selenium (Se) was dissolved in 1 ml of colorless trioctylphosphine (TOP, 97%, from ABCR) at 200° C. under inert gas (6-24 h). The reaction product formed was trioctylphosphine selenide (TopSe). The reaction was ended once a clear, colorless solution was obtained. The 1 molar Se precursor solution was stored at room temperature (20° C.) with exclusion of air.

### EXAMPLE 2 (NONINVENTIVE)

### Synthesis of CdSe Nanoparticles

The reaction medium, also called matrix, consisted of hexadecylamine (HDA, 98%, from Molekula) and trioctylphosphine oxide (TOPO, 99%, from Aldrich) in a molar ratio of 6:4. The matrix was simultaneously the solvent and ligand for the formation of CdSe nanoparticles in the temperature range between 100° C. and 300° C. In addition, TOPO prevented the decomposition of Cd(SA)₂ at high temperatures, for example 300° C. The molar ratio of Cd to Se was 1:1, while the molar ratio of Cd or Se to the matrix was 1:100. All subsequent synthesis steps in this example were conducted under inert gas atmosphere (nitrogen).

### 2.1 Monomerization of HDA

HDA was heated to 300° C. for at least 5 minutes in order to monomerize the HDA, which tends to form micelles. The resulting increased effective HDA concentration makes a crucial contribution to the stabilization and quality of the CdSe nanoparticles, since only monomeric HDA is an effective ligand for CdSe nanoparticles.

### 2.2 Reaction Mixture

0.1 mmol of solid Cd(SA)₂ (111 mg) was dissolved in 40 mmol of TOPO (1.5465 g) while heating (approx. 100° C.), combined with 60 mmol of monomerized liquid HDA at about 100° C. (1.449 g) and heated to 300° C. Subsequently, the colorless solution was admixed rapidly with 0.1 ml of the Se precursor solution (0.1 mmol of Se in 0.1 ml of TOP). An immediate color change to red indicated the formation of CdSe nanoparticles. The reaction solution was held at 300° C. for at least 2 hours. During this time, a rise in the photoluminescence intensity was observed. This observation can be interpreted as a change in the surface with correction of surface defects. The ligand shell increased in size during this time and protected the nanoparticles from what is called Ostwald ripening, i.e. the uncontrolled growth of some nanoparticles at the expense of other nanoparticles. This firstly minimizes the formation of additional defect sites and secondly prevents the increase in size inhomogeneity.

### EXAMPLE 3 (NONINVENTIVE)

### Conventional Purification of the CdSe Nanoparticles

1 ml of the synthesis product from example 2.2 was dissolved in 3 ml of chloroform. Then 6 ml of methanol were added. The CdSe nanoparticles were removed by centrifugation.

### EXAMPLE 4

### Inventive Treatment of the CdSe Nanoparticles

12 ml of hexanoic acid and 20 ml of methanol with a temperature of 100° C. were added to 1 ml of the synthesis product from example 2.2. The precipitated CdSe nanoparticles were subsequently removed by centrifugation. 3 ml of chloroform and 6 ml of methanol were added to the CdSe nanoparticles at a temperature of 85° C. Subsequently, the nanoparticles were centrifuged off again and dispersed in anhydrous 1,2-dichlorobenzene (DCB).

FIG. 3 shows the UV-vis absorption and photoluminescence spectra of the CdSe nanoparticles before and after the inventive treatment with hexanoic acid. Before the treatment, a first absorption band at 606 nm is evident, with a corresponding photoluminescence emission band at 622 nm. The emission band has a width (full width at half maximum) of 29 nm.

The absorption spectrum of the nanoparticles in the chloroform solution after the acid treatment is virtually unchanged compared to that before the acid treatment—the inventive treatment apparently has no influence on the absorption properties of the nanoparticles. In contrast, the emission band has disappeared in the case of the nanoparticles treated in accordance with the invention. This is attributed to the effective removal of excess ligands around the nanoparticles, which leads to lower passivation of the nanoparticles. This increases the number of radiationless decomposition processes via surface defects and/or energy release to the surrounding solvent.

H¹, C¹³ and P³¹ nuclear resonance spectra (not shown) demonstrate that the HDA synthesis ligand is still present on the surface of the nanoparticles and no ligand exchange has taken place.

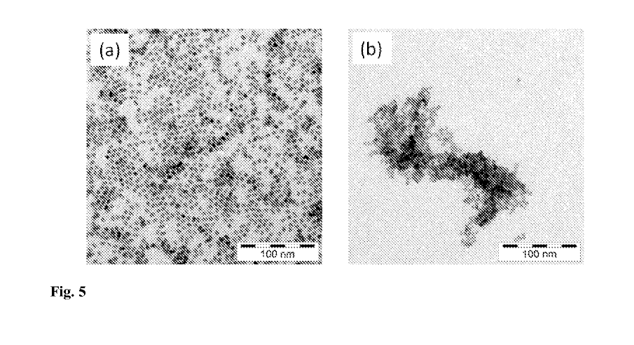

Transmission electron microscopy images (TEM) confirmed that the mean particle diameter was reduced significantly by the inventive treatment (see FIG. 5). The untreated nanoparticles from example 3 are shown in the TEM images (Zeiss (LEO) 912 Omega) as well-separated individual particles (FIG. 5(a)), whereas the treated nanoparticles are in the form of larger agglomerates (FIG. 5(b)), which is important in photovoltaic cells for the formation of percolation pathways between the particles.

In addition, studies by means of dynamic light scattering (DLS) showed a significant reduction in the effective particle diameter in the case of nanoparticles treated in accordance with the invention compared to untreated nanoparticles.

FIG. 4 shows the size distribution, determined by means of DLS (Zetasizer Nano Series ZS, Malvern), of treated and untreated nanoparticles. It is clearly evident that the effective particle size after the inventive treatment has fallen by more than two orders of magnitude. At the same time, in hybrid solar cells (see example 5), an improvement in the efficiency (PCE=power conversion efficiency) of 0.01% in the case of untreated nanoparticles to a value of 2.0% in the case of nanoparticles treated in accordance with the invention was observed. The hydrodynamic diameter of about 200 nm in the case of untreated nanoparticles is unusually high, and the presence of agglomerates in the dispersion cannot be ruled out. Hydrophobic interactions which are caused by additionally adsorbed ligands and lead to aggregation in the dispersion are very likely. Nevertheless, the DLS studies show the overall decreasing trend in particle size. The hydrodynamic diameter of about 10 nm in the case of the CdSe nanoparticles treated in accordance with the invention is a realistic value, which is in agreement with the TEM images and the UV-vis studies.

### EXAMPLE 5 (NONINVENTIVE)

The CdSe nanoparticles from examples 3 and 4 were dispersed in anhydrous 1,2-dichlorobenzene (DCB), so as to give a concentration of about 15 mg/ml.

Solutions of CdSe nanoparticles in anhydrous 1,2-dichlorobenzene were mixed with different amounts of P3HT (regioregular purity >98.5%, Sigma Aldrich) and applied to a surface of a PEDOT:PSS layer by means of spin-coating.

The layer thickness of the P3HT/CdSe layers was about 80-100 nm, measured by means of a profilometer. Aluminum electrodes were applied to these layers with a thickness of 112.5 nm, by means of thermal vapor deposition. The active area was about 0.08 cm².

These photovoltaic cells were heat-treated at a temperature of 145° C. for 10 minutes in a nitrogen-flooded chamber (glovebox) and then heat-treated at a temperature of 160° C. for 10 minutes.

Once the cells had cooled (about 20° C.), current density-voltage curves were recorded in the nitrogen-flooded chamber.

The solar cell with the best properties was produced from a mixture of 87 percent by weight of CdSe nanoparticles treated in accordance with the invention in P3HT under AM1.5G illumination of 100 mW/cm². The short-circuit voltage (V_{oc}) was 623 mV, the short-circuit current density (J_{sc}) 5.8 mA/cm², the fill factor (FF) 0.56 and the efficiency (PCE=power conversion efficiency) 2.0%.

The wavelength-dependent short-circuit quantum efficiency (EQE=External Quantum Efficiency) showed a maximum of 50% under irradiation 0.67 mW/cm² at 455 nm, which is in agreement with results in scientific publications (see, for example, W. U. Huynh, J. J. Dittmer, and A. P. Alivisatos, Science 295, 2425 (2002)).

1. A process for treatment of nanoparticles to which a ligand R_{L}—X is bonded by a polar head group X and a tail R_{L}, said process comprising contacting nanoparticles with a substance Y which forms, with the ligand R_{L}—X, a chemical compound which can be removed from the nanoparticles by washing.

2. The process as claimed in claim 1, wherein said nanoparticles have a core of a II-VI semiconductor, optionally of CdS, CdSe, CdTe and/or a ternary mixed system thereof.

3. The process as claimed in claim 1, wherein said head group X of said ligand R_{L}—X is a carboxylate group and said substance Y is an amine NR₁R₂R₃ or an ammonium compound +NR₁R₂R₃R₄ with the R₁ to R₄ radicals, where the R₁ to R₃ or R₁ to R₄ radicals are each hydrogen, alkyl, alkenyl, alkynyl or aryl groups.

4. The process as claimed in claim 1, wherein said head group X of said ligand R_{L}—X is an amino group NR₁R₂R₃ with R₁ to R₃ radicals, where the R₁ to R₃ radicals are each hydrogen, alkyl, alkenyl, alkynyl or aryl groups, and said substance Y is a carboxylic acid and/or a carboxylate compound.

5. The process as claimed in claim 1, wherein said nanoparticles have a greatest dimension in a range from 1.5 nm to 50 nm.

6. Nanoparticles produced by a process as claimed in claim 1.

7. Nanoparticles as claimed in claim 6, capable of being used as an electron acceptor and/or an electron donor in a hybrid solar cell.

8. A solar cell comprising said nanoparticles as claimed in claim 6.

9. A process for enhancing efficiency of a hybrid solar cell, comprising treating semiconductive nanoparticles which are used as an electron acceptor and/or an electron donor in a hybrid solar cell beforehand by a process as claimed in claim 1.
